(19) United States
(12) Patent Application Publication
(10) Pub. No.: US 2018/0092013 A1
(43) Pub. Date: Mar. 29, 2018

(54) MONITORING INITIATION OF VIDEO CALLS ON A WIRELESS COMMUNICATION NETWORK

(71) Applicant: T-Mobile USA, Inc., Bellevue, WA (US)

(72) Inventor: Rajesh Garre, Redmond, WA (US)

(21) Appl. No.: 15/277,829

(22) Filed: Sep. 27, 2016

(51) Int. Cl. H04W 36/22; H04W 36/14; H04W 24/08; H04L 29/06

(52) U.S. Cl. CPC H04W 36/22; H04W 36/14; H04W 84/042; H04L 65/1066; H04W 24/08

(57) ABSTRACT

A method of determining initiation of video calls over a wireless communication network that uses counters within an application server. A number of video calls initiated on the wireless communication network utilizing a first wireless access technology during a period of time is determined by the counters. A number of video calls initiated on the wireless communication network utilizing a second wireless access technology during a period of time is determined by the counters. Based upon the counting, a percentage of video calls initiated on the wireless communication network utilizing the first and second wireless access technologies is derived.

### BACKGROUND

In recent years, telecommunication devices have advanced from offering simple voice calling services within wireless networks to providing users with many new features. Telecommunication devices now provide messaging services such as email, text messaging, and instant messaging; data services such as Internet browsing; media services such as storing and playing a library of favorite songs; location services; and many others. In addition to the new features provided by the telecommunication devices, users of such telecommunication devices have greatly increased. Such an increase in users is only expected to continue and in fact, it is expected that there could be a growth rate of twenty times more users in the next few years alone. Such an increase in wireless traffic implies more demand and less radio resource availability, which likely leads to the degradation of the wireless network performance.

Currently, many wireless networks allow for video calls to be made over long term evolution networks (LTE or ViLTE). Utilizing services over an LTE network, such as, for example, calls, internet access, etc., results in charges for users of the wireless networks. Additionally, video calls may result in an additional cost for users since video calls include a video component and a voice component. However, accessing a wireless network utilizing Wi-Fi generally does not result in charges for users.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 illustrates a wireless communication network, in accordance with various embodiments.

FIG. 2 graphically illustrates an example of a comparison of percentages of daily video calls initiated utilizing LTE access protocols and Wi-Fi access protocols on the wireless communication network of FIG. 1.

FIG. 3 is a flowchart illustrating a method of determining initiation of video calls over the wireless communication network of FIG. 1, in accordance with various embodiments.

### DETAILED DESCRIPTION

Described herein is a wireless communication network that includes techniques and architecture for determining and monitoring the initiation of video calls made on the wireless communication network. For example, a telephony application server (TAS), either located within the wireless communication network or separately therefrom, includes counters that count the number of users that initiate video calls on the wireless communication network utilizing long-term evolution (LTE) wireless access protocols and standards to access the wireless communication network. The counters also count the number of users that initiate video calls on the wireless communication network utilizing Wi-Fi wireless access protocols and standards to access the wireless communication network. Generally, the counters can measure or count the number of video calls that are initiated utilizing radio access technology for accessing the wireless communication network, e.g., LTE access technology and Wi-Fi technology.

In embodiments, the counters measure or count the number of video calls that are initiated utilizing LTE access technology to access the wireless communication network for making the video call during a time period. The counters also measure or count the number of video calls that are initiated utilizing Wi-Fi access technology to access the wireless communication network for making the video call during the time period. A percentage can then be determined as to the number of video calls that are made utilizing LTE access technology and Wi-Fi access technology for making the video calls over the wireless communication network during the time period. In embodiments, the counters may also count or monitor video calls that are made utilizing a different access technology to access the wireless communication network for making the video calls during the time period.

Additionally, the counters can also measure or count the number of video calls that are initiated by Wi-Fi access technology and then handed off to LTE radio access technology. Likewise, the counters can also measure or count the number of calls that are initiated by utilizing LTE access technology and then handed off to Wi-Fi access technology.

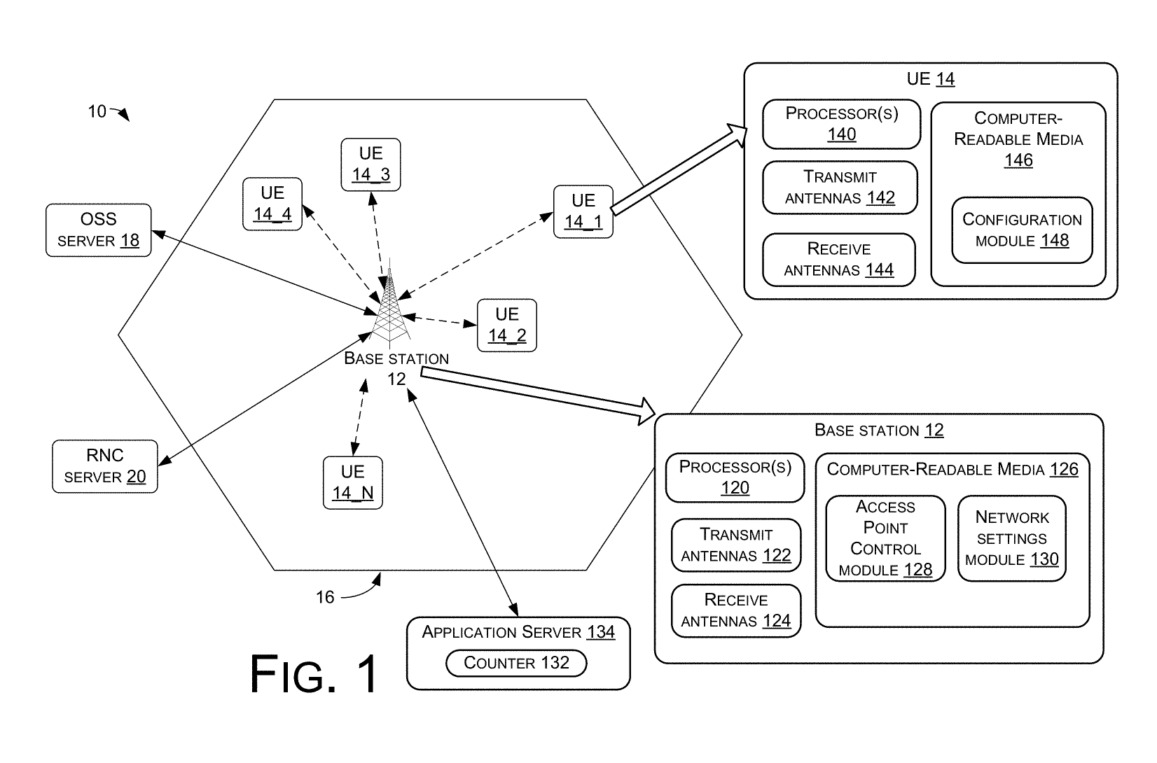

FIG. 1 illustrates a wireless communication network 10 (also referred to herein as network 10). The network 10 comprises a base station (BS) 12 communicatively coupled to a plurality of user devices, referred to as UEs 14_1, 14_2, . . . , 14_N, where N is an appropriate integer. The BS 12 serves UEs 14 located within a geographical area, e.g., within a macro cell 16. FIG. 1 illustrates the macro cell 16 to be hexagonal in shape, although other shapes of the macro cell 16 may also be possible. In general, the network 10 comprises a plurality of macro cells 16, with each macro cell 16 including one or more BSs 12.

In an embodiment, the UEs 14_1, . . . , 14_N may comprise any appropriate devices for communicating over a wireless communication network. Such devices include mobile telephones, cellular telephones, mobile computers, Personal Digital Assistants (PDAs), radio frequency devices, handheld computers, laptop computers, tablet computers, palmtops, pagers, integrated devices combining one or more of the preceding devices, and/or the like. As such, UEs 14_1, . . . , 14_N may range widely in terms of capabilities and features. For example, one of the UEs 14_1, . . . , 14_N may have a numeric keypad, a capability to display only a few lines of text and be configured to interoperate with only Global System for Mobile Communications (GSM) networks. However, another of the UEs 14_1, . . . , 14_N (e.g., a smart phone) may have a touch-sensitive screen, a stylus, an embedded GPS receiver, and a relatively high-resolution display, and be configured to interoperate with multiple types of networks. UEs 14_1, . . . , 14_N may also include SIM-less devices (i.e., mobile devices that do not contain a functional subscriber identity module (“SIM”)), roaming mobile devices (i.e., mobile devices operating outside of their home access networks), and/or mobile software applications.

In an embodiment, the BS 12 may communicate voice traffic and/or data traffic with one or more of the UEs 14_1, . . . , 14_N. The BS 12 may communicate with the UEs 14_1, . . . , 14_N using one or more appropriate wireless communication protocols or standards. For example, the BS 12 may communicate with the UEs 14_1, . . . , 14_N using one or more standards, including but not limited to GSM, Internet Protocol (IP) Multimedia Subsystem (IMS), Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), Wi-Fi protocols (including IEEE 802.11 protocols), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like.

The BS 12 may be communicatively coupled (e.g., using a backhaul connection, illustrated using solid lines in FIG. 1) to a number of backhaul equipments, e.g., an operation support subsystem (OSS) server 18, a radio network controller (RNC) 20, and/or the like. The RNC 20 can also be in the form of a mobility management entity when the wireless communication network 10 operates according to the long term evolution (LTE) standard or LTE Advanced standard.

In an embodiment, the base station 12 may comprise processors 120, one or more transmit antennas (transmitters) 122, one or more receive antennas (receivers) 124, and computer-readable media 126. The processors 120 may be configured to execute instructions, which may be stored in the computer-readable media 126 or in other computer-readable media accessible to the processors 120. In some embodiments, the processors 120 are a central processing unit (CPU), a graphics processing unit (GPU), or both CPU and GPU, or any other sort of processing unit. The base station 12 can also be in the form of a Node B (where the wireless communication network 10 is 3G UMTS network) or in the form of an eNode B (where the wireless communication network 10 operates according to the LTE standard or LTE Advanced standard).

The one or more transmit antennas 122 may transmit signals to the UEs 14_1, . . . , 14_N, and the one or more receive antennas 124 may receive signals from the UEs 14_1, . . . , 14_N. The antennas 122 and 124 include any appropriate antennas known in the art. For example, antennas 122 and 124 may include radio transmitters and radio receivers that perform the function of transmitting and receiving radio frequency communications. In an embodiment, the antennas 122 and 124 may be included in a transceiver module of the BS 12.

The computer-readable media 126 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the base station 12. The computer-readable media 126 may reside within the base station 12, on one or more storage devices accessible on a local network to the base station 12, on cloud storage accessible via a wide area network to the base station 12, or in any other accessible location.

The computer-readable media 126 may store modules, such as instructions, data stores, and so forth that are configured to execute on the processors 120. For instance, the computer-readable media 126 may store an access point control module 128 and a network settings module 130, as will be discussed in more detail herein later.

Although FIG. 1 illustrates the computer-readable media 126 in the BS 12 storing the access point control module 128 and the network settings module 130, in various other embodiments, the access point control module 128, the network settings module 130, and one or more other modules (not illustrated, may be stored in another component of the network 10 (e.g., other than the BS 12). For example, one or more of these modules may be stored in a computer-readable media included in the OSS server 18, the RNC 20, another appropriate server associated with the network 10, and/or the like.

Although not illustrated in FIG. 1, various other modules (e.g., an operating system module, basic input/output systems (BIOS), etc.) may also be stored in the computer-readable media 126. Furthermore, although not illustrated in FIG. 1, the base station 12 may comprise several other components, e.g., a power bus configured to supply power to various components of the base station 12, one or more interfaces to communicate with various backhaul equipment, and/or the like.

In an embodiment, the UEs 14 may comprise processors 140, one or more transmit antennas (transmitters) 142, one or more receive antennas (receivers) 144, and computer-readable media 146. The processors 140 may be configured to execute instructions, which may be stored in the computer-readable media 146 or in other computer-readable media accessible to the processors 140. In some embodiments, the processors 140 is a central processing unit (CPU), a graphics processing unit (GPU), or both CPU and GPU, or any other sort of processing unit. The one or more transmit antennas 142 may transmit signals to the base station 12, and the one or more receive antennas 144 may receive signals from the base station 12. In an embodiment, the antennas 142 and 144 may be included in a transceiver module of the UE 14.

The computer-readable media 146 may also include CRSM. The CRSM may be any available physical media accessible by a computing device to implement the instructions stored thereon. CRSM may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which can be used to store the desired information and which can be accessed by the UE 14.

The computer-readable media 146 may store several modules, such as instructions, data stores, and so forth that are configured to execute on the processors 140. For instance, the computer-readable media 140 may store a configuration module 148. Although not illustrated in FIG. 1, the computer-readable media 146 may also store one or more applications configured to receive and/or provide voice, data and messages (e.g., short message service (SMS) messages, multi-media message service (MMS) messages, instant messaging (IM) messages, enhanced message service (EMS) messages, etc.) to and/or from another device or component (e.g., the base station 12, other UEs, etc.).

Although not illustrated in FIG. 1, the UEs 14 may also comprise various other components, e.g., a battery, a charging unit, one or more network interfaces, an audio interface, a display, a keypad or keyboard, a GPS receiver and/or other location determination component, and other input and/or output interfaces.

Although FIG. 1 illustrates only one UE (UE 14_1) in detail, each of the UEs 14_2, . . . , 14_N may have a structure that is at least in part similar to that of the UE 14_1. For example, similar to the UE 14_1, each of the UEs 14_2, . . . , 14_N may comprise processors, one or more transmit antennas, one or more receive antennas, and computer-readable media including a configuration module.

In an embodiment, the network settings module 130 stored in the computer-readable media 126 maintains a plurality of network settings associated with the network 10. Individual network settings maintained by the network settings module 130 may be pertinent to a single UE of the UEs 14_1, . . . , 14_N, a subset of the UEs 14_1, . . . , 14_N, or each of the UEs 14_1, . . . , 14_N. For example, a network setting of the plurality of network settings may specify a maximum bit rate at which a UE (or each of the UEs 14_1, . . . , 14_N) may transmit data to the BS 12. Another network setting of the plurality of network settings may specify a transmit time interval (tti) used by each of the UEs 14_1, . . . , 14 N to transmit data to the BS 12. Yet another network setting of the plurality of network settings may specify a maximum power that each of the UEs 14_1, . . . , 14 N may use to transmit data to the BS 12. The plurality of network settings maintained by the network settings module 130 may also include any other appropriate type of network settings.

In an embodiment, one or more of the plurality of network settings maintained by the network settings module 13 may be communicated to the UEs 14_1, . . . , 14_N (e.g., by the transmit antennas 122 to the receive antennas 144 of the UEs 14_1, . . . , 14_N). Based on receiving the network settings, the UEs 14_1, . . . , 14_N (e.g., the corresponding configuration modules 148) may configure themselves and communicate with the BS 12 accordingly.

Generally, the network 10 is made up of multiple macro cells 16. Thus, depending on the configuration and size, the network 10 can represent and serve various regional areas, e.g., a city, a state, an entire nation, the whole world, etc.

In embodiments, a counter 132 is located within an application server (AS) 134. In an embodiment, the application server 134 is a telephony application server (TAS). The application server 134 may be located within the network 10 at various locations. In embodiments, the application server 134 may be located within the OSS server 18 or the RNC 20. The network 10 may include multiple application servers 134, and therefore multiple counters 132. Furthermore, each application server 134 may include more than one counter 132 to help keep track of various parameters. The application server(s) 134 may be located outside the network 10.

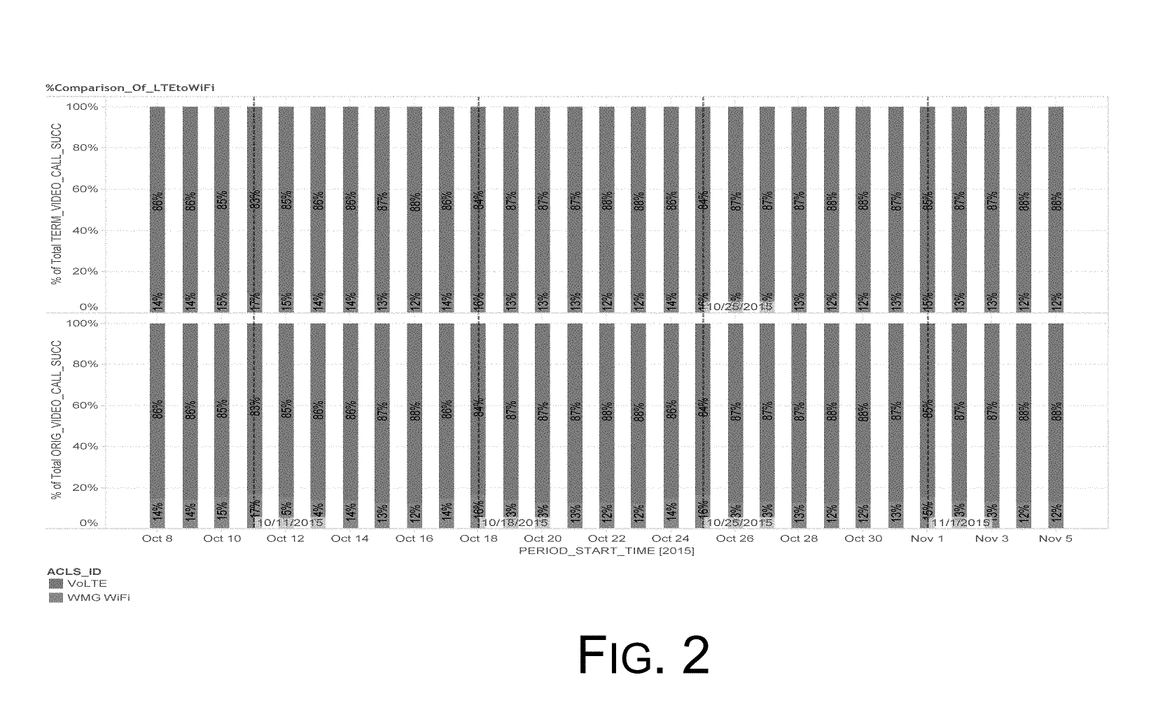

As previously noted, in embodiments, the counters 132 measure or count the number of video calls that are initiated by UEs 14 utilizing LTE access technology to access the wireless communication network 10 for making video calls during a time period. The counters 132 also measure or count the number of video calls that are initiated by UEs 14 utilizing Wi-Fi access technology (e.g., utilizing a wireless local access network (WLAN) in accordance with IEEE 802.11 protocols and standards) to access the wireless communication network 10 for making video calls during the time period. A percentage can then be determined as to the number of video calls that are made utilizing LTE access technology and Wi-Fi access technology for making the video calls over the wireless communication network 10 during the time period. FIG. 2 illustrates an example of a comparison of percentages of daily video calls initiated utilizing LTE access protocols and Wi-Fi access protocols. In embodiments, the counters 132 may also count or monitor video calls that are made utilizing a different access technology to access the wireless communication network 10 for making the video calls during the time period.

Additionally, the counters 132 can also measure or count the number of video calls that are initiated by UEs 14 utilizing Wi-Fi access technology and then handed off to LTE radio access technology. Likewise, the counters 132 can also measure or count the number of calls that are initiated by UEs 14 utilizing LTE access technology and then handed off to Wi-Fi access technology.

The evaluation of video calls initialization on the wireless communication network 10 can be used with the various wireless communication network protocols or standards previously mentioned above. More particularly, the evaluation of video calls initialization can be used for services that are based on an IMS network, such as, for example, voice-over LTE (VoLTE), video-over LTE (ViLTE), Wi-Fi calling, voice-over Wi-Fi (VoWiFi), rich communication services (RCS) and web RTC. The time period for measuring and counting the calls may be hourly, daily, every 15 minutes, etc., depending on the desired granularity. Thus, depending on results of the evaluation, operators of wireless communication networks 10 may begin charging users utilizing Wi-Fi access technologies during peak periods of access and/or for general usage of the wireless communication network 10 during any period of usage.

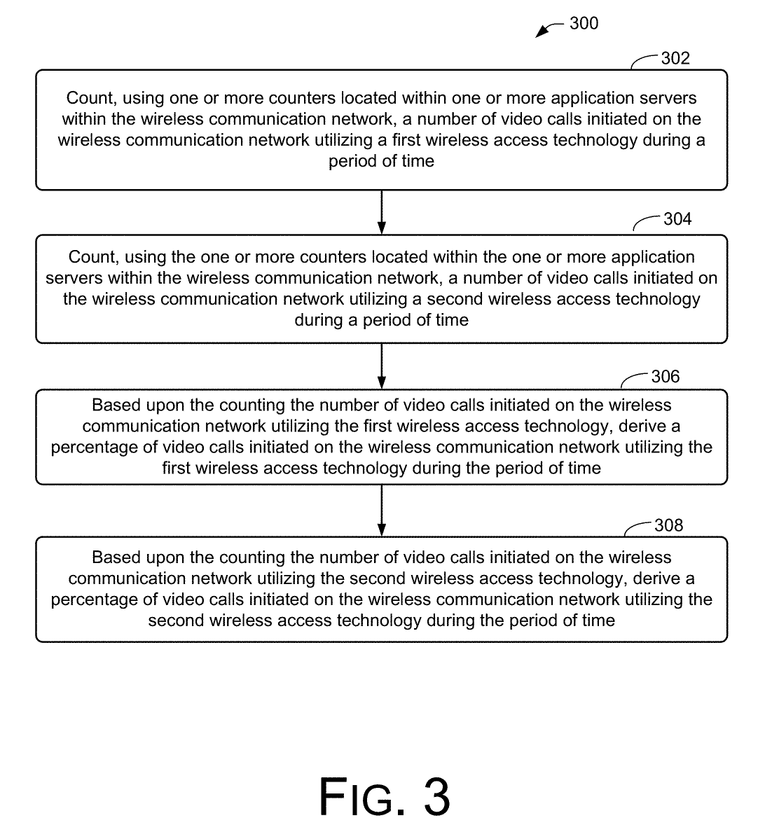

FIG. 3 is a flow diagram of an illustrative process that may be implemented within the wireless communication network 10. This process (as well as other processes described throughout) are illustrated as a logical flow graph, each operation of which represents a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Furthermore, while the architectures and techniques described herein have been described with respect to wireless networks, the architectures and techniques are equally applicable to processors and processing cores in other environments and computing devices.

FIG. 3 is a flowchart illustrating a method 300 of determining initiation of video calls over a wireless communication network, e.g., the wireless communication network 10. As illustrated, at block 302, one or more counters located within one or more application servers within the wireless communication network, count a number of video calls initiated on the wireless communication network utilizing a first wireless access technology during a period of time. At block 304, the one or more counters located within the one or more application servers within the wireless communication network count a number of video calls initiated on the wireless communication network utilizing a second wireless access technology during the period of time. At block 306, based upon the counting the number of video calls initiated on the wireless communication network utilizing the first wireless access technology, a percentage of video calls initiated on the wireless communication network utilizing the first wireless access technology during the period of time is derived. At block 308, based upon the counting the number of video calls initiated on the wireless communication network utilizing the second wireless access technology, a percentage of video calls initiated on the wireless communication network utilizing the second wireless access technology during the period of time is derived.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

I claim:

1. A method of determining initiation of video calls over a wireless communication network, the method comprising:
counting, using one or more counters located within one or more telephony application servers (TASs) within the wireless communication network, a number of video calls initiated on the wireless communication network utilizing a first wireless access technology during a period of time;
counting, using the one or more counters located within the one or more TASs within the wireless communication network, a number of video calls initiated on the wireless communication network utilizing a second wireless access technology during the period of time;
based upon the counting the number of video calls initiated on the wireless communication network utilizing the first wireless access technology, deriving a percentage of video calls initiated on the wireless communication network utilizing the first wireless access technology during the period of time; and
based upon the counting the number of video calls initiated on the wireless communication network utilizing the second wireless access technology, deriving a percentage of video calls initiated on the wireless communication network utilizing the second wireless access technology during the period of time.

2. The method of claim 1, wherein the period of time is one of either (i) daily or (ii) hourly.

3. The method of claim 1, further comprising at least one of (i) counting, using the one or more counters located within the one or more TASs, the number of video calls that are initiated by the first wireless access technology and handed off to the second wireless access technology or (ii) counting, using the one or more counters located within the one or more TASs, the number of video calls that are initiated by the second wireless access technology and handed off to the first wireless access technology.

4. The method of claim 1, wherein the first wireless access technology is based on long term evolution (LTE) protocols.

5. The method of claim 4, wherein the second wireless access technology is based on Wi-Fi protocols.

6. The method of claim 1, wherein the first wireless access technology is based on Wi-Fi protocols.

7. The method of claim 1, wherein the application server is located outside the wireless communication network.

8. The method of claim 1, wherein the application server is located within the wireless communication network.

9. An apparatus comprising:
a non-transitory storage medium; and
instructions stored in the non-transitory storage medium, the instructions being executable by the apparatus to
count a number of video calls initiated on a wireless communication network utilizing a first wireless access technology during a period of time;
count a number of video calls initiated on the wireless communication network utilizing a second wireless access technology during the period of time;
based upon the counting the number of video calls initiated on the wireless communication network utilizing the first wireless access technology, derive a percentage of video calls initiated on the wireless communication network utilizing the first wireless access technology during the period of time; and
based upon the counting the number of video calls initiated on the wireless communication network utilizing the second wireless access technology, derive a percentage of video calls initiated on the wireless communication network utilizing the second wireless access technology during the period of time.

10. The apparatus of claim 9, wherein the period of time is one of either (i) daily or (ii) hourly.

11. The apparatus of claim 9, wherein the instructions are executable by the apparatus to at least one of (i) count the number of video calls that are initiated by the first wireless access technology and handed off to the second wireless access technology or (ii) count the number of video calls that are initiated by the second wireless access technology and handed off to the first wireless access technology.

12. The apparatus of claim 9, wherein the first wireless access technology is based on long term evolution (LTE) protocols.

13. The apparatus of claim 12, wherein the second wireless access technology is based on Wi-Fi protocols.

14. The apparatus of claim 9, wherein the first wireless access technology is based on Wi-Fi protocols.

15. The apparatus of claim 9, wherein the apparatus comprises an application server located outside the wireless communication network.

16. The apparatus of claim 9, wherein the apparatus comprises an application server located within the wireless communication network.

17. A wireless communication network comprising an apparatus comprising a non-transitory storage medium and instructions stored in the non-transitory storage medium, the instructions being executable by the apparatus to:
count a number of video calls initiated on the wireless communication network utilizing a first wireless access technology during a period of time;
count a number of video calls initiated on the wireless communication network utilizing a second wireless access technology during the period of time;
based upon the counting the number of video calls initiated on the wireless communication network utilizing the first wireless access technology, derive a percentage of video calls initiated on the wireless communication network utilizing the first wireless access technology during the period of time; and
based upon the counting the number of video calls initiated on the wireless communication network utilizing the second wireless access technology, derive a percentage of video calls initiated on the wireless communication network utilizing the second wireless access technology during the period of time.

18. The wireless communication network of claim 17, wherein the first wireless access technology is based on long term evolution (LTE) protocols.

19. The wireless communication network of claim 18, wherein the second wireless access technology is based on Wi-Fi protocols.

20. The wireless communication network of claim 17, wherein the first wireless access technology is based on Wi-Fi protocols.

21. The wireless communication network of claim 17, wherein the apparatus comprises an application server located outside the wireless communication network.

22. The wireless communication network of claim 17, wherein the apparatus comprises an application server located within the wireless communication network.
